(19) United States
(12) Patent Application Publication
(10) Pub. No.: US 2015/0303549 A1
(43) Pub. Date: Oct. 22, 2015

(54) Electronic Device Connector Structures With Antennas

(71) Applicant: Apple Inc., Cupertino, CA (US)

(72) Inventors: Erdinc Irci, Sunnyvale, CA (US); Robert W. Schlub, Cupertino, CA (US); Mattia Pascolini, San Francisco, CA (US); Matthew A. Mow, Los Altos, CA (US); Thomas E. Biedka, San Jose, CA (US)

(73) Assignee: Apple Inc., Cupertino, CA (US)

(21) Appl. No.: 14/258,877

(22) Filed: Apr. 22, 2014

(51) Int. Cl. H01Q 1/24

(52) U.S. Cl. CPC H01Q 1/24

(57) ABSTRACT

An electronic device may have radio-frequency transceiver circuitry for transmitting and receiving antenna signals using an antenna. The antenna may be formed within a connector port in the electronic device or may be formed on an external cable that is coupled to the connector port. The antenna may have an antenna resonating element that is formed from a signal wire in the external cable or that is formed from a metal structure mounted to the external cable. The radio-frequency transceiver circuitry may be directly coupled to the antenna resonating element using springs or other direct coupling mechanisms or may be coupled to the antenna resonating element using a coupling structure. The coupling structure may include a capacitor electrode, an inductor, or other structures for coupling to the antenna resonating element by electromagnetic near-field coupling.

### BACKGROUND

This relates generally to electronic devices and, more particularly, to electronic devices with antennas.

Electronic devices often include antennas. For example, cellular telephones, computers, and other devices often contain antennas for supporting wireless communications.

It can be challenging to form electronic device antenna structures with desired attributes. In some wireless devices, the presence of conductive structures such as electronic components and housing structures can influence antenna performance. Antenna performance may not be satisfactory if the conductive structures are not configured properly and interfere with antenna operation. Device size can also affect performance. It can be difficult to achieve desired performance levels in a compact device, particularly when the compact device has conductive housing structures and electronic components with conductive structures.

It would therefore be desirable to be able to provide improved antenna arrangements for electronic devices.

### SUMMARY

An electronic device may have radio-frequency transceiver circuitry for transmitting and receiving antenna signals. The antenna signals may be transmitted and received using an antenna. The antenna may be formed within a connector port in the electronic device or may be formed on an external cable that is coupled to the connector port. The external cable may have a flexible length of cable coupled to a plug. The plug and the connector port may have corresponding sets of mating contacts. Wires in the cable may carry power or data signals.

The antenna may have an antenna resonating element that is formed from a signal wire in the external cable or that is formed from a separate metal structure mounted to the external cable. The radio-frequency transceiver circuitry may be directly coupled to the antenna resonating element using springs or other direct coupling mechanisms or may be indirectly coupled to the antenna resonating element using a near-field coupling structure. The coupling structure may include a capacitor electrode, an inductor, or other structures for coupling to the antenna resonating element by electromagnetic near-field coupling.

### BRIEF DESCRIPTION OF THE DRAWINGS

FIG. 1 is a perspective view of an illustrative electronic device such as a laptop computer in accordance with an embodiment.

FIG. 2 is a perspective view of an illustrative electronic device such as a handheld electronic device in accordance with an embodiment.

FIG. 3 is a perspective view of an illustrative electronic device such as a tablet computer in accordance with an embodiment.

FIG. 4 is a perspective view of an illustrative electronic device such as a display for a computer or television in accordance with an embodiment.

FIG. 5 is a schematic diagram of illustrative circuitry in an electronic device in accordance with an embodiment.

FIG. 6 is a diagram of an illustrative antenna in accordance with an embodiment.

FIG. 7 is a perspective view of an illustrative electronic device having connector ports that are coupled to external cables in accordance with an embodiment.

FIG. 8 is a view of a portion of a housing in which an antenna has been formed within a port for a cable in accordance with an embodiment.

FIG. 9 is a cross-sectional side view of a portion of an electronic device housing having a connector port in which an antenna structure and antenna cavity been formed in accordance with an embodiment.

FIG. 10 is a cross-sectional side view of an illustrative cable with antenna structures that has been received within a connector port in an electronic device in accordance with an embodiment.

FIG. 11 is a diagram of a cable with an embedded antenna resonating element that is separate from signal wires in the cable in accordance with an embodiment.

FIG. 12 is a diagram of a cable with an illustrative helical antenna resonating element that is separate from signal wires in the cable in accordance with an embodiment.

FIG. 13 is a cross-sectional side view of a portion of an illustrative cable with antenna structures directly coupled to signal paths in an electronic device using springs in accordance with an embodiment.

FIG. 14 is a cross-sectional side view of a cable with antenna structures and a transmission line coupled to signal paths in an electronic device in accordance with an embodiment.

FIG. 15 is a cross-sectional side view of a cable with an antenna resonating element structure that is capacitively coupled to a coupling structure and signal path in an electronic device in accordance with an embodiment.

FIG. 16 is a perspective view of a cable having an antenna resonating element and an electronic device that are inductively coupled in accordance with an embodiment.

FIG. 17 is a cross-sectional side view of an illustrative cable with antenna structures that are near-field coupled to near-field coupling structures in an electronic device in accordance with an embodiment.

FIG. 18 is a diagram showing how a cable that is coupled to circuitry in an electronic device may have conductive structures such as signal wires that form an antenna in the cable in accordance with an embodiment.

### DETAILED DESCRIPTION

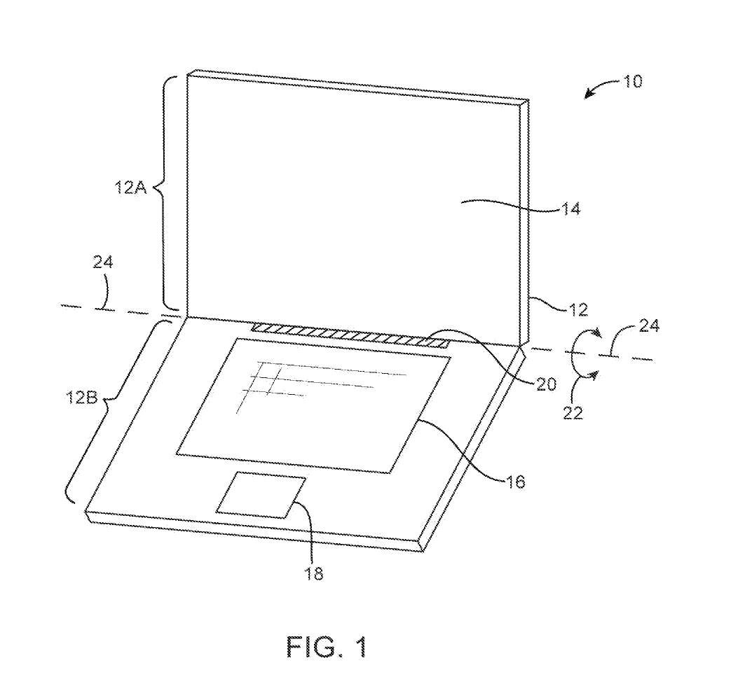

Electronic devices may have connector ports. The connector ports may be used in forming antennas. The connector ports may receive connectors that are attached to cables and other structures. The cables may also include antenna structures. The incorporating of antenna structures within a connector port in a device or an external cable or other accessory may help enhance wireless performance for an electronic device. Illustrative electronic devices of the type that may use these antenna arrangements are shown in FIGS. 1, 2, 3, and 4.

Electronic device 10 of FIG. 1 has the shape of a laptop computer and has upper housing 12A and lower housing 12B with components such as keyboard 16 and touchpad 18. Device 10 has hinge structures 20 (sometimes referred to as a clutch barrel) to allow upper housing 12A to rotate in directions 22 about rotational axis 24 relative to lower housing 12B. Display 14 is mounted in housing 12A. Upper housing 12A, which may sometimes be referred to as a display housing or lid, is placed in a closed position by rotating upper housing 12A towards lower housing 12B about rotational axis 24.

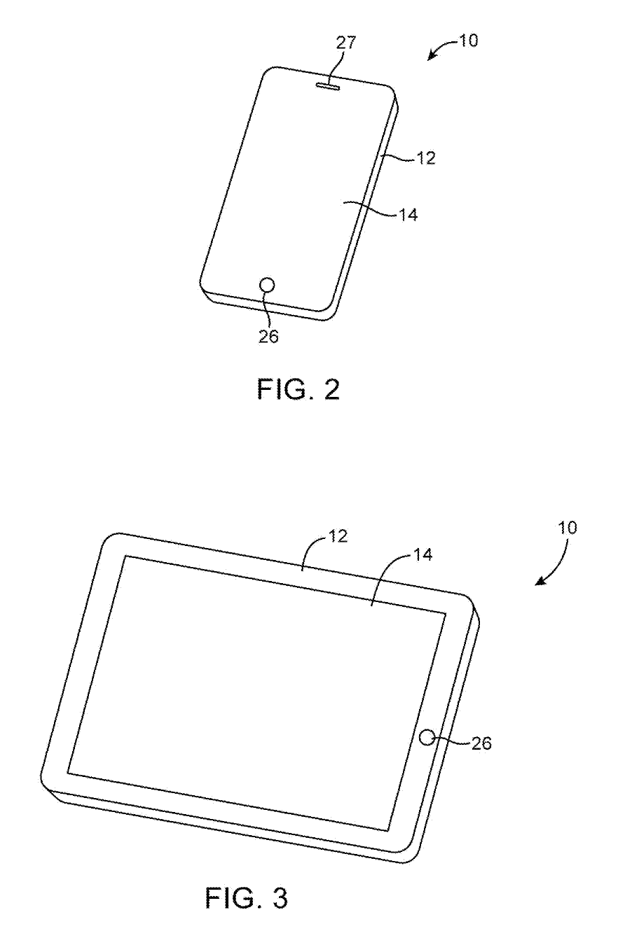

FIG. 2 shows an illustrative configuration for electronic device 10 based on a handheld device such as a cellular telephone, music player, gaming device, navigation unit, or other compact device. In this type of configuration for device 10, device 10 has opposing front and rear surfaces. The rear surface of device 10 may be formed from a planar portion of housing 12. Display 14 forms the front surface of device 10. Display 14 may have an outermost layer that includes openings for components such as button 26 and speaker port 27.

In the example of FIG. 3, electronic device 10 is a tablet computer. In electronic device 10 of FIG. 3, device 10 has opposing planar front and rear surfaces. The rear surface of device 10 is formed from a planar rear wall portion of housing 12. Curved or planar sidewalls may run around the periphery of the planar rear wall and may extend vertically upwards. Display 14 is mounted on the front surface of device 10 in housing 12. As shown in FIG. 3, display 14 has an outermost layer with an opening to accommodate button 26.

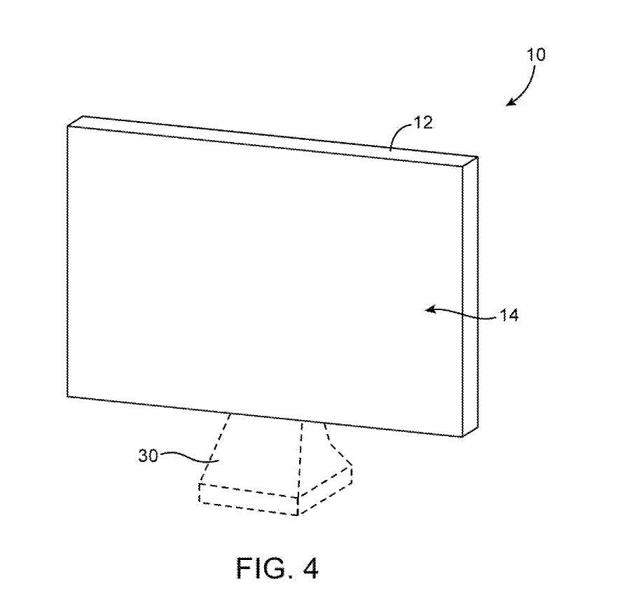

FIG. 4 shows an illustrative configuration for electronic device 10 in which device 10 is a computer display, a computer that has an integrated computer display, or a television. Display 14 is mounted on a front face of device 10 in housing 12. With this type of arrangement, housing 12 for device 10 may be mounted on a wall or may have an optional structure such as support stand 30 to support device 10 on a flat surface such as the surface of a table.

An electronic device such as electronic device 10 of FIGS. 1, 2, 3, and 4, may, in general, be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment. The examples of FIGS. 1, 2, 3, and 4 are merely illustrative.

Device 10 may include a display such as display 14. Display 14 may be mounted in housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal housing structure, one or more structures that form exterior housing surfaces, etc.).

In general, housing 12 may be formed from conductive materials such as metal (e.g., aluminum, stainless steel, etc.) and/or insulating materials (e.g., plastic, fiber-composites, etc.). Antennas in device 10 may be mounted behind plastic portions of housing 12, behind plastic antenna windows formed within openings in a metal housing, under dielectric structures such as glass or plastic portions of display 14, or elsewhere in device 10 where antenna signals will not be blocked by the presence of conductive structures. Antennas in device 10 may also be mounted in connector ports or may be formed from portions of cables that are plugged into connector ports in device 10.

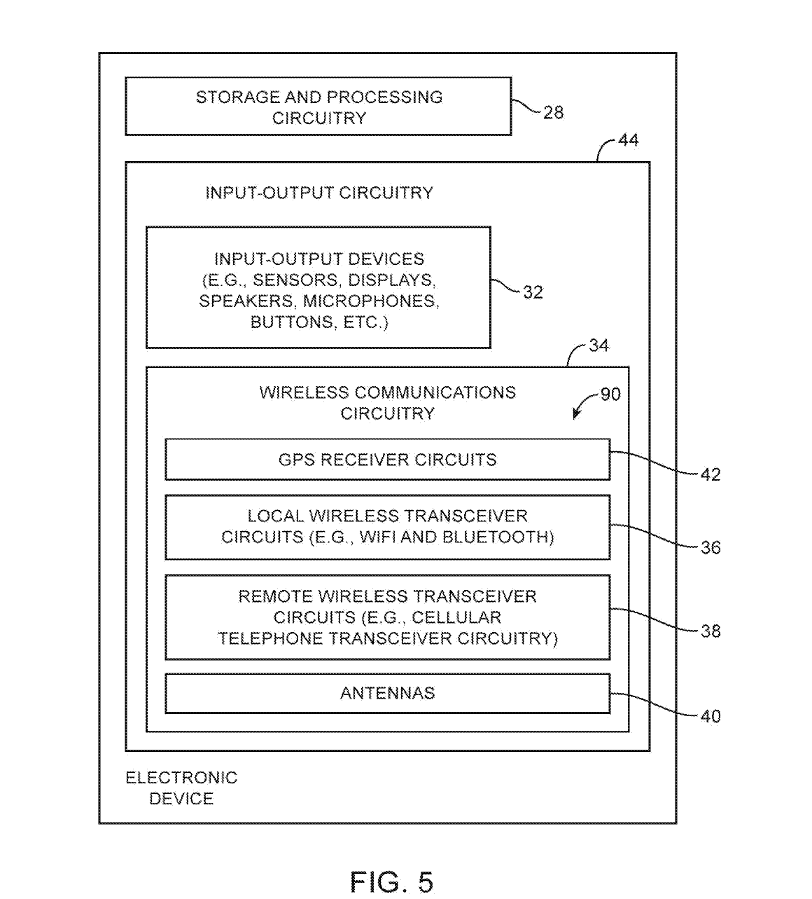

A schematic diagram showing illustrative components that may be used in device 10 is shown in FIG. 5. As shown in FIG. 5, device 10 may include control circuitry such as storage and processing circuitry 28. Storage and processing circuitry 28 may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in storage and processing circuitry 28 may be used to control the operation of device 10. This processing circuitry may be based on one or more microprocessors, microcontrollers, digital signal processors, application specific integrated circuits, etc.

Storage and processing circuitry 28 may be used to run software on device 10, such as internet browsing applications, voice-over-internet-protocol (VOIP) telephone call applications, email applications, media playback applications, operating system functions, etc. To support interactions with external equipment, storage and processing circuitry 28 may be used in implementing communications protocols. Communications protocols that may be implemented using storage and processing circuitry 28 include internet protocols, wireless local area network protocols (e.g., IEEE 802.11 protocols—sometimes referred to as WiFi®), protocols for other short-range wireless communications links such as the Bluetooth® protocol, cellular telephone protocols, MIMO protocols, antenna diversity protocols, etc.

Input-output circuitry 44 may include input-output devices 32. Input-output devices 32 may be used to allow data to be supplied to device 10 and to allow data to be provided from device 10 to external devices. Input-output devices 32 may include user interface devices, data port devices, and other input-output components. For example, input-output devices may include touch screens, displays without touch sensor capabilities, buttons, joysticks, click wheels, scrolling wheels, touch pads, key pads, keyboards, microphones, cameras, buttons, speakers, status indicators, light sources, audio jacks and other audio port components, digital data port devices, light sensors, motion sensors (accelerometers), capacitance sensors, proximity sensors, etc.

Input-output circuitry 44 may include wireless communications circuitry 34 for communicating wirelessly with external equipment. Wireless communications circuitry 34 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

Wireless communications circuitry 34 may include radio-frequency transceiver circuitry 90 for handling various radio-frequency communications bands. For example, circuitry 34 may include transceiver circuitry 36, 38, and 42. Transceiver circuitry 36 may be wireless local area network transceiver circuitry that may handle 2.4 GHz and 5 GHz bands for WiFi® (IEEE 802.11) communications and that may handle the 2.4 GHz Bluetooth® communications band. Circuitry 34 may use cellular telephone transceiver circuitry 38 for handling wireless communications in frequency ranges such as a low communications band from 700 to 960 MHz, a midband from 1710 to 2170 MHz, and a high band from 2300 to 2700 MHz or other communications bands between 700 MHz and 2700 MHz or other suitable frequencies (as examples). Circuitry 38 may handle voice data and non-voice data. Wireless communications circuitry 34 can include circuitry for other short-range and long-range wireless links if desired. For example, wireless communications circuitry 34 may include 60 GHz transceiver circuitry, circuitry for receiving television and radio signals, paging system transceivers, near field communications (NFC) circuitry, etc. Wireless communications circuitry 34 may include satellite navigation system circuitry such as global positioning system (GPS) receiver circuitry 42 for receiving GPS signals at 1575 MHz or for handling other satellite positioning data. In WiFi® and Bluetooth® links and other short-range wireless links, wireless signals are typically used to convey data over tens or hundreds of feet. In cellular telephone links and other long-range links, wireless signals are typically used to convey data over thousands of feet or miles.

Wireless communications circuitry 34 may include antennas 40. Antennas 40 may be formed using any suitable antenna types. For example, antennas 40 may include antennas with resonating elements that are formed from loop antenna structures, patch antenna structures, inverted-F antenna structures, slot antenna structures, planar inverted-F antenna structures, helical antenna structures, hybrids of these designs, etc. Different types of antennas may be used for different bands and combinations of bands. For example, one type of antenna may be used in forming a local wireless link antenna and another type of antenna may be used in forming a remote wireless link antenna.

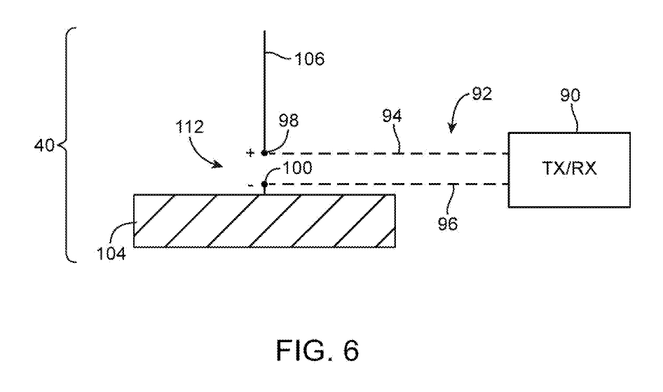

As shown in FIG. 6, transceiver circuitry 90 in wireless circuitry 34 may be coupled to antenna structures 40 using paths such as path 92. To provide antenna structures 40 with the ability to cover communications frequencies of interest, antenna structures 40 may be provided with circuitry such as filter circuitry (e.g., one or more passive filters and/or one or more tunable filter circuits). Discrete components such as capacitors, inductors, and resistors may be incorporated into the filter circuitry. Capacitive structures, inductive structures, and resistive structures may also be formed from patterned metal structures (e.g., part of an antenna). If desired, antenna structures 40 may be provided with adjustable circuits such as tunable components that tune antenna structures 40 over communications bands of interest. Tunable components in antenna structures 40 may include tunable inductors, tunable capacitors, or other tunable components. Tunable components such as these may be based on switches and networks of fixed components, distributed metal structures that produce associated distributed capacitances and inductances, variable solid state devices for producing variable capacitance and inductance values, tunable filters, or other suitable tunable structures. During operation of device 10, control circuitry 28 (FIG. 5) may issue control signals adjust inductance values, capacitance values, or other parameters associated with the tunable components, thereby tuning antenna structures 40 to cover desired communications bands. Configurations in which antenna structures 40 are fixed and are not tuned with adjustable components may also be used.

Path 92 may include one or more transmission lines. As an example, signal path 92 of FIG. 6 may be a transmission line having a positive signal conductor such as line 94 and a ground signal conductor such as line 96. Lines 94 and 96 may form parts of a coaxial cable or a microstrip transmission line on a substrate such as a printed circuit (as examples). A matching network formed from components such as inductors, resistors, and capacitors may be used in matching the impedance of antenna structures 40 to the impedance of transmission line 92. Matching network components may be provided as discrete components (e.g., surface mount technology components) or may be formed from housing structures, printed circuit board structures, traces on plastic supports, etc. Components such as these may also be used in forming filter circuitry in antenna structures 40.

Transmission line 92 may be directly coupled to an antenna resonating element and ground for antenna 40 or may be coupled to near-field-coupled antenna feed structures that are used in indirectly feeding a resonating element for antenna 40. As an example, antenna structures 40 may form a monopole antenna of the type shown in FIG. 6 that is fed by transmission line 92 at antenna feed 112. As shown in FIG. 6, antenna feed 112 of antenna 40 has a positive antenna feed terminal such as terminal 98 and a ground antenna feed terminal such as ground antenna feed terminal 100. Positive transmission line conductor 94 may be coupled to positive antenna feed terminal 98 and ground transmission line conductor 96 may be coupled to ground antenna feed terminal 92.

Monopole antenna 40 of FIG. 6 has antenna resonating element 106 and antenna ground (ground plane) 104. If desired, antenna structures 40 may include an antenna resonating element such as a slot antenna resonating element, inverted-F antenna resonating element, patch antenna resonating element, loop antenna resonating element, or other suitable antenna resonating element. The example of FIG. 6 in which antenna 40 is a monopole antenna is merely illustrative. Antenna 40 may be directly fed or may be indirectly fed using a near-field coupled feed structure.

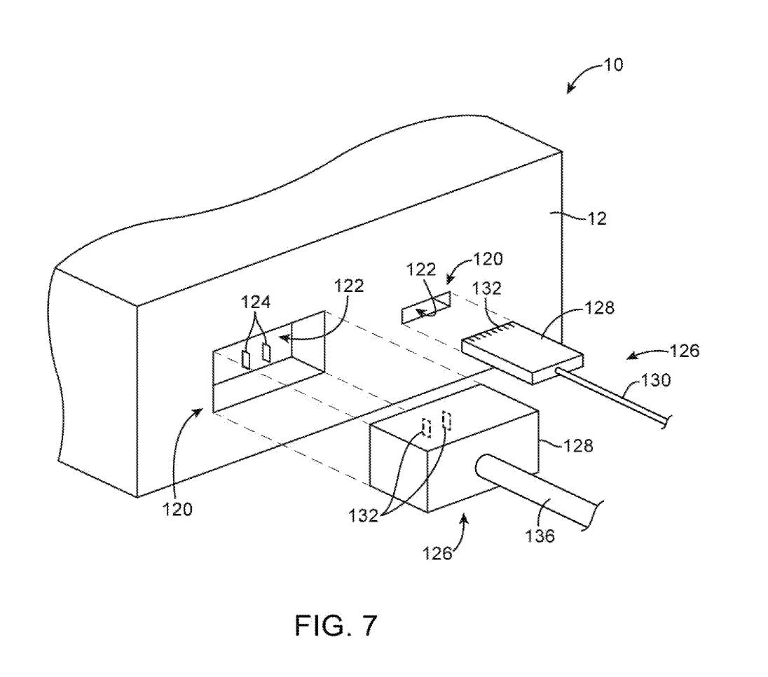

FIG. 7 is a perspective view of a portion of housing 12 of device 10 showing how device 10 may have one or more connector ports such as ports 120. Cables 126 may be coupled to device 10 using ports 120. Cables 126 may have male or female plugs such as connectors 128. Connectors 128 may be coupled to wires that are housed within a plastic jacket (see, e.g., cables 130 of FIG. 7). The wiring of cables 130 may include metal shielding, plastic insulated wires, coaxial cable structures such as an outer grounding layer surrounding a center conductor, or other conductive paths. Plugs 128 may include power plugs, data plugs, audio plugs, analog plugs, and plugs for handling power signals and digital and/or analog data signals. Plugs 128 may include contacts (pins) 132 that are coupled to respective signal paths (e.g., wires) in cables 130. Ports 120 in housing 12 may have cavities 122 or other features that are adapted to receive mating plugs 128 for cables 126. When plugs 128 are inserted into cavities 122 of ports 120, plug contacts such as contacts 132 may mate with corresponding contacts in ports 120 such as contacts 124. Cables 126 may be stand-alone cables (e.g., cables for coupling together multiple pieces of electronic equipment) or may form portions of an accessory (e.g., a pair of headphones, a component with a cable pigtail, etc.).

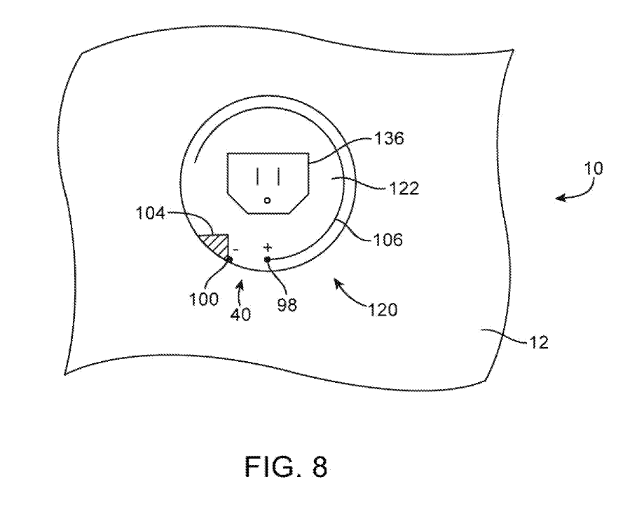

If desired, antenna 40 may be formed using antenna structures mounted in a connector port. Consider, as an example, port 120 of FIG. 8. In the example of FIG. 8, connector port 120 is formed from cavity 122 in electronic device housing 12 of electronic device 10. Connector structures 136 may include contacts for mating with corresponding contacts on a power plug or other external connector when the plug is inserted within cavity 122. Antenna 40 may be formed from conductive antenna structures that are mounted within cavity 122. Conductive structures for antenna 40 may be mounted on or near the exposed surfaces of cavity 122 and/or other portions of housing 12, may be formed within plastic parts that are mounted in cavity 122 or adjacent to cavity 122, or may be formed in other suitable portions of device 10 in the vicinity of connector port 120. The conductive structures for antenna 40 may include antenna resonating element 106 and ground plane portion 104 in the example of FIG. 8.

In many device configurations, it may be difficult or impossible to form antennas 40 within device 10 (e.g., due to space constraints, due to shielding effects from the presence of metal in housing 12, etc.). As a result, the ability to form one or more antennas such as antenna 40 of FIG. 8 in connector ports such as port 120 of FIG. 8 (e.g., portions of device 10 that are not blocked by metal housing walls) may enhance wireless performance for device 10.

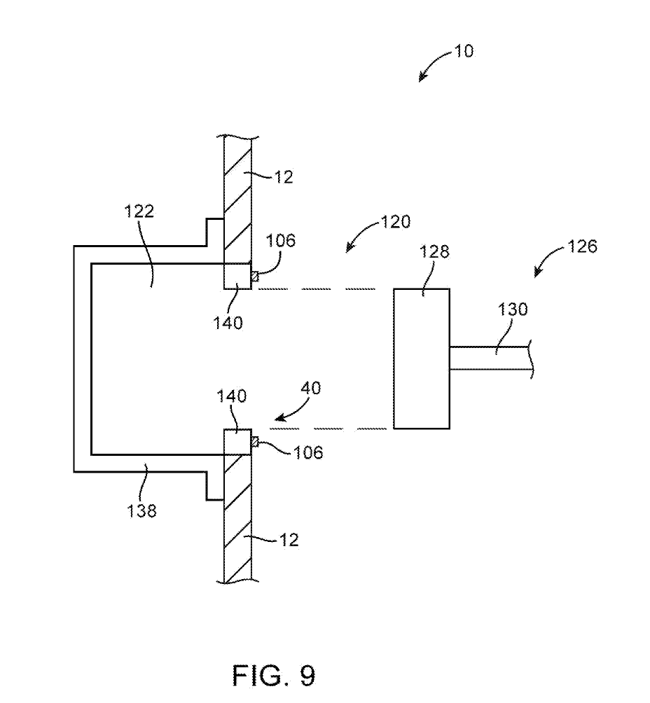

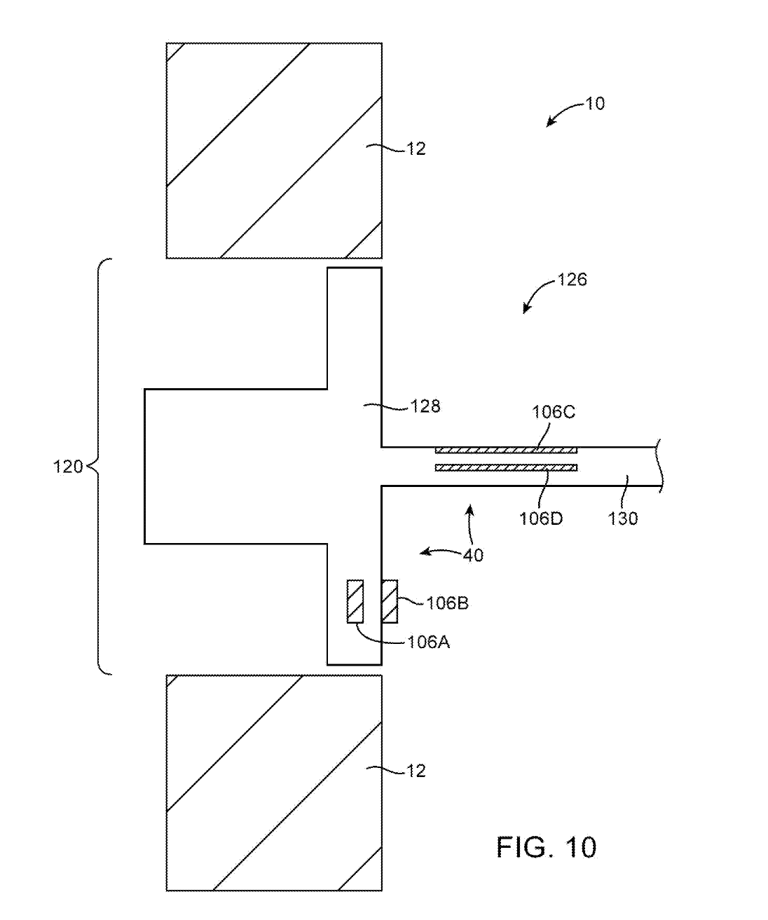

As shown in the illustrative cross-sectional side view of FIG. 9, connector port 120 may have a metal shielding structure such as metal structure 138. Metal structure 138 may be a metal can with walls that form cavity 122. Metal structure 138 may form a conductive antenna cavity for a cavity antenna and/or may help shield internal structures in device 10 from electromagnetic interference during the operation of antenna 40. Housing 12 may be formed from a conductive material such as metal (as an example). In this situation, antenna resonating element 106 may be formed by metal traces on a dielectric support structure such as illustrative plastic support structure 140 of FIG. 9 (as an example).

In addition to or instead of forming antennas 40 using structures mounted within the interior of housing 12 and/or within connector ports 120, one or more antennas 40 may be formed using conductive structures associated with cables 126. A cross-sectional side view of cable 126 showing illustrative locations for forming antenna structures is shown in FIG. 10. In the example of FIG. 10, cable 126 has plug 128 and cable 130. Plug 128 may have contacts (not shown) that mate with corresponding contacts in port 120 when plug 128 is mounted within port 120 in housing 12 of device 10. As shown by illustrative antenna structure 106A, a metal structure such as a portion of antenna resonating element 106 of FIG. 6 or other metal antenna structure may be embedded within plug 128 of cable 126 (e.g., a plastic plug). With this type of arrangement, potentially unsightly antenna structures are hidden from view by a user of device 10. A metal antenna structure may also be formed on an inner surface of plug 128 or on the outer surface of plug 128, as illustrated by metal antenna structure 106B. Particularly in compact cables, the size of plug 128 may be relatively small, which may limit antenna size. Larger antennas can be implemented using conductive paths in cable 130 such as illustrative metal structure 106C on an outer portion of cable 130 (e.g., a metal structure on an external surface of cable 130 that is separate from any signal paths in cable 130) and, if desired, embedded structures in cable 130 such as embedded metal structure 106D. Embedded metal structure 106D may be a dedicated antenna structure that is separate from the signal paths in cable 130 or may form part of a structure such as a wire or a shield that also carries analog and/or digital data signals, or power or other signals for device 10. If desired, combinations of these approaches may be used in forming antenna(s) 40 in device 10.

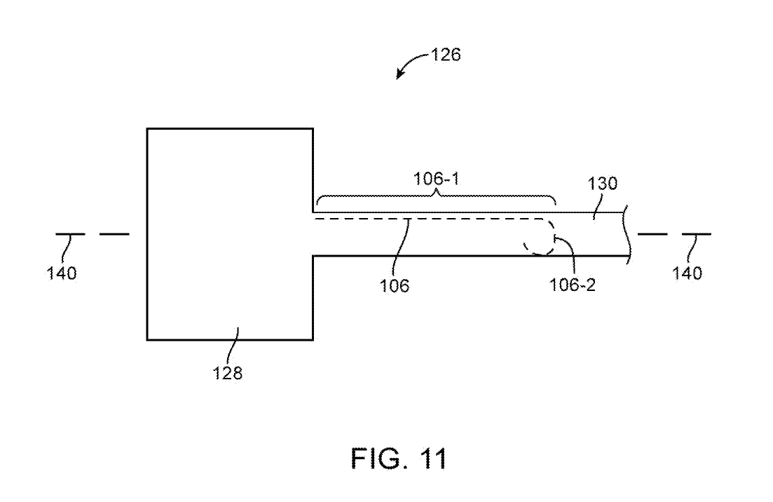

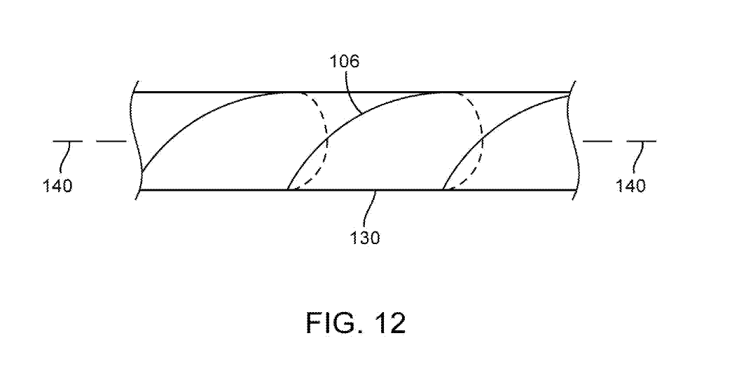

FIG. 11 is a side view of cable 126 showing how metal structure 106 may have portions such as portion 106-1 that extend along longitudinal axis 140 of flexible cable portion 130 of cable 126 and optional portions such as portion 106-2 that wrap around some or all of the circumference (periphery) of cable 130. As shown in the example of FIG. 12, metal structure 106 (e.g., an antenna resonating element) may wrap around cable 130 and longitudinal cable axis 140 in a helix. Other configurations for incorporating metal antenna structures (e.g., resonating element 106) into cable 126 may be used, if desired.

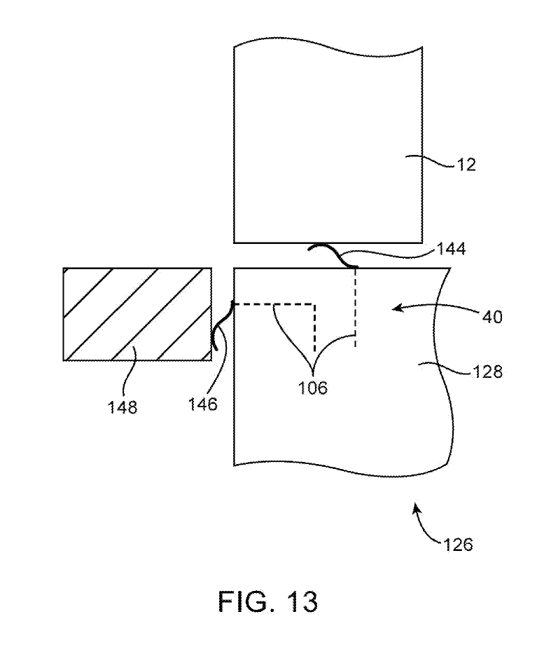

As shown in FIG. 13, antenna 40 may include conductive structures for forming direct connections between transceiver circuitry in device 10 and antenna structures in external structures such as plug 128 of cable 126. As shown in FIG. 13, for example, antenna 40 may be formed from metal structures 106 (e.g., antenna resonating element structures) mounted on plug 128 and/or other portions of cable 126. Springs 144 and 146 may be used to form direct connections between radio-frequency transceiver circuitry in device 10 and antenna structures 106 in cable 126 (e.g., plug 128, etc.). The transceiver circuitry in device 10 may be coupled to a transmission line path or other conductive paths in device 10. For example, a ground path in path 92 may be coupled to a metal housing structure such as housing 12 of FIG. 13 and a positive signal path in path 92 may be coupled to a metal structure such as illustrative internal metal structure 148. Structure 148 may be a metal trace on a printed circuit board, an internal housing structure, part of a transmission line on a flexible printed circuit, part of a coaxial cable transmission line, etc. Metal structures 106 of FIG. 13 may form antenna resonating structures and other structures for antenna 40. In the illustrative configuration of FIG. 13, springs such a springs 144 and 146 have been used to couple the signals paths in device 10 to metal structures 106 in plug 128 of cable 126 (and, if desired, metal structures 106 in cable 130). Springs 144 and 146 may be formed from strips of metal that serve as springs, from springs such as spring-loaded pins, from coil springs, from leaf springs, etc. If desired, other resilient contact structures may be used to form the direct connections formed by springs 144 and 146 of FIG. 13.

Springs 144 and 146 may be mounted to structures in device 10 (e.g., structures 148, housing 12, etc.) or may be mounted on plug 128 of cable 126. The use of springs 146 and 144 allows plug 128 to be removed from device 10 when it is desired to decouple cable 126. When plug 128 and cable 126 are attached to device 10, springs 144 and 146 will form connections between the radio-frequency transceiver circuitry in device 10 and antenna structures 106 in plug 128. These connections are broken when plug 128 is removed from connector port 120.

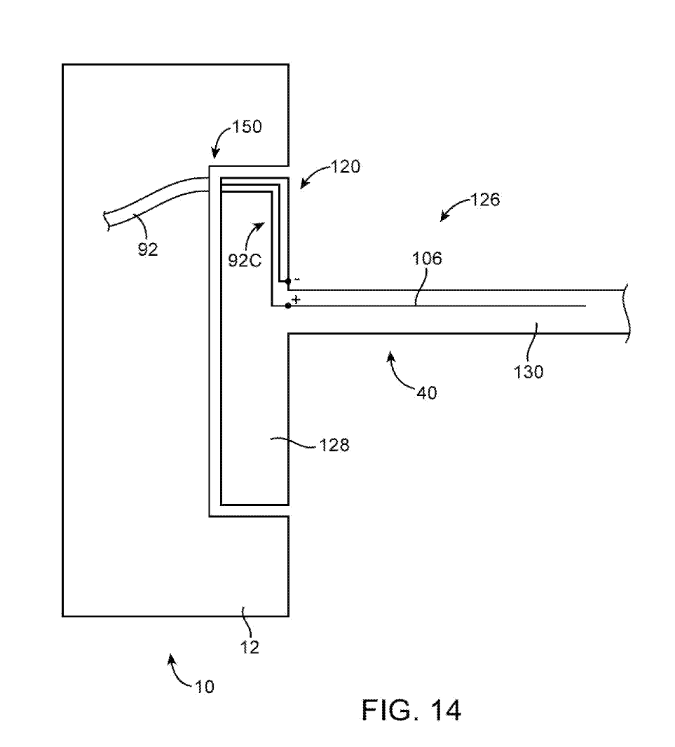

FIG. 14 is a diagram showing how transmission line structures may be incorporated into a portion of cable 126. In the FIG. 14 example, cable 126 has elongated flexible cable portion 130 and plug 128. Plug 128 or other connector in cable 126 may be coupled to a mating connector in a connector port of device 10 (e.g., port 120 of FIG. 14). Transmission line 92 in device 10 may be coupled to transmission line portion 92C in cable 126. Transmission line portion 92C may include positive and ground signal lines. These signal lines may be coupled to corresponding positive and ground signal lines in path 92 (e.g., using springs, etc.). Transmission line 92C may run between the point at which transmission line 92 in device 10 is coupled to transmission line 92 in cable 126 (see, e.g., point 150 of FIG. 14) and conductive structures in antenna 40 such as resonating element structure 160 (at positive terminal “+” of FIG. 14) and ground (at ground terminal “−” of FIG. 14). Other configurations for coupling transmission line 92 to antenna structures 40 may be used if desired. The incorporation of a length of transmission line 92C into cable 126 is merely illustrative.

In addition to or instead of coupling transmission line path 92 to antenna structures in cable 126, signal paths in device 10 can be coupled to antenna structures in cable 126 using near-field electromagnetic coupling (e.g., capacitive coupling and/or inductive coupling, or other coupling configurations in which near-field electromagnetic signals are coupled between a signal path in device 10 and a corresponding antenna structure in cable 126).

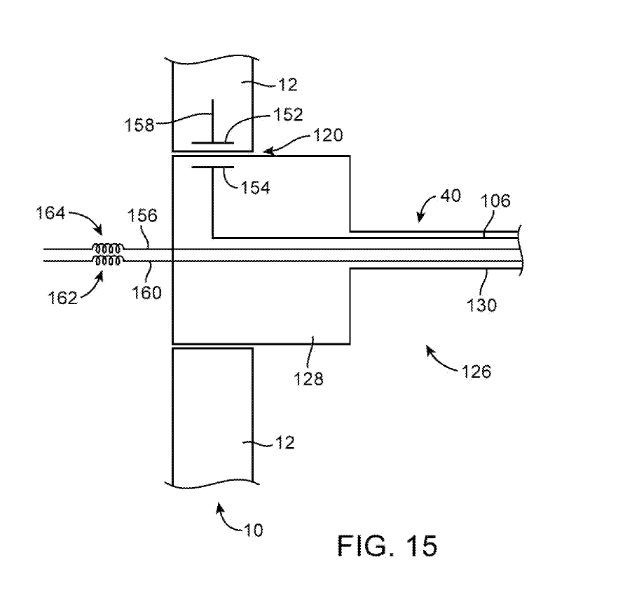

As an example, device 10 may have a capacitor electrode such as electrode 152 of FIG. 15. Electrode 152 may be embedded within housing 12 (e.g., a plastic portion of a housing wall structure) or may be mounted on other structures in device 10 in the vicinity of connector port 120. Cable 126 may have a flexible cable portion such as flexible portion 130 that contains metal structures such as power lines, data lines, etc. Some of the structures in cable 130 or elsewhere in cable 126 (e.g., structures in plug 128) may be used in forming antenna 40 (see, e.g., illustrative antenna resonating element 106). Antenna resonating element 106 may be connected to capacitor electrode 154. Capacitor electrode 154 may be embedded within plug 128 (e.g., in a configuration in which plug 128 is formed from a dielectric such as plastic), may be formed on the outside of plug 128, or may otherwise be mounted to plug 128. When cable 126 is coupled to device 10 by inserting plug 128 into connector port 120, electrode 154 of cable 126 will be aligned with capacitor 152 in connector port 120 as shown in FIG. 15. The relatively close proximity between electrode 152 and electrode 154 capacitively couples antenna signal path 158 in device 10 to antenna resonating element 106 in cable 126. An antenna ground path can likewise be formed between an antenna ground in device 10 and an antenna ground in cable 126. The use of a capacitive coupling arrangement to couple path 158 (e.g., a positive transmission line path in transmission line 92) and antenna resonating element 106 is merely illustrative.

During antenna operations, radio-frequency antenna signals are conveyed between antenna 40 (e.g., antenna resonating element 106 of FIG. 15) and signal paths in device 10 such as path 158. Cable 126 may have power and/or data paths such as paths 156 and 160. Paths 156 and 160 may be wires or other conductors that are separate from the conductive structures forming antenna resonating element 106, but which may pick up interference from nearby antenna resonating element 106. To prevent radio-frequency signals that are associated with antenna 40 from interfering with internal circuitry in device 10, inductors such as inductors 164 and 162 may be interposed within paths 156 and 160, respectively. Inductors 164 and 162 will block radio-frequency interference that is generated due to the operation of antenna 40 and will thereby prevent this radio-frequency interference from interfering with the operation of circuitry in device 10. Inductors such as inductors 164 and 162 may be placed, for example, on the power lines in a power cord. Inductors 162 and 164 may be included in cable 126 or may be incorporated into device 10 in the vicinity of port 120. Inductors 162 and 164 may be used in a configuration for device 10 with capacitively coupled antenna paths, inductively coupled antenna paths, paths for antenna 40 that are directly coupled between device 10 and cable 126 (e.g., using springs), may be used in a configuration for device 10 in which antenna structures are formed within connector port 120, or may be otherwise incorporated in the signal paths for the wires or other conductors in cable 126 to block signal interference.

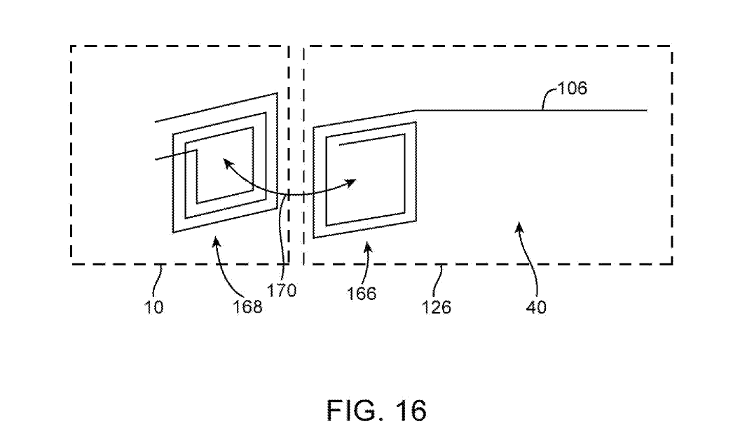

FIG. 16 illustrates how inductive coupling can be used to couple radio-frequency transceiver circuitry in device 10 and antenna 40 in cable 126. As shown in FIG. 16, cable 126 may include inductor 166 and device 10 may include corresponding inductor 168. Inductors 166 and 168 may be formed from loops of wires, metal traces formed in one or more concentric loops, or other inductor structures. As an example, inductor 166 may be formed from loops of metal on plug 128 of cable 126 and mating inductor 168 in device 10 may be mounted to a housing sidewall or other structure in connector port 120. When cable 126 is plugged into port 120, inductors 166 and 168 will be sufficiently close to be electromagnetically coupled through near-field electromagnetic signals 170. Radio-frequency transceiver circuitry 90 in device 10 may have transmission line conductors or other antenna signal paths coupled to one or more inductors such as inductor 168. During signal transmission operations, antenna 40 receives signals to be transmitted via inductive coupling between inductors 168 and 166. During antenna signal reception operations, received antenna signals from antenna 40 are passed to transceiver circuitry 90 in device 10 using inductive coupling.

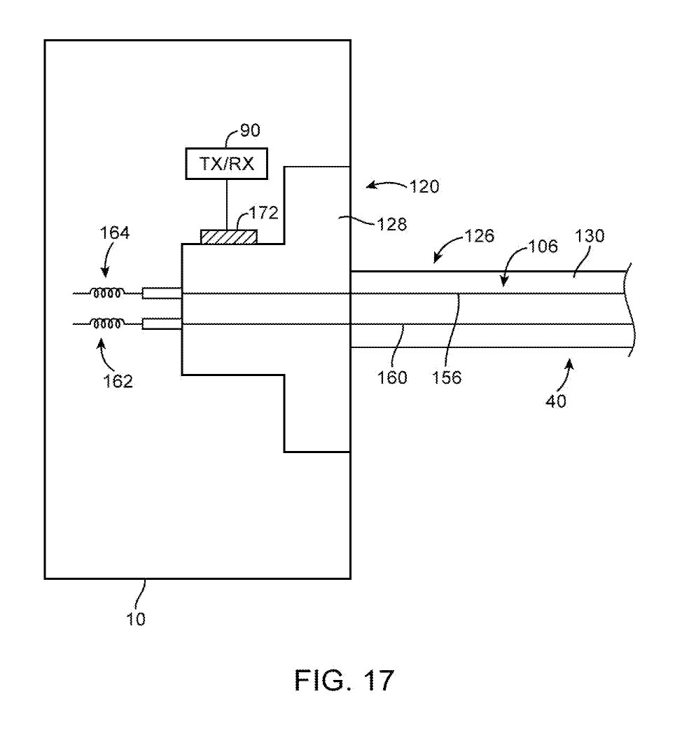

In the illustrative configuration of FIG. 17, device 10 includes a coupling structure such as near-field coupling structure 172. Coupling structure 172 may include capacitive coupling structures such as capacitor electrode structures, may include inductive coupling structures, or may include other structures for near-field coupling between transceiver 90 and one or more signal lines in cable 126. In the example of FIG. 17, cable 130 may have signal lines such as wires 156 and 160. Wires 156 and 160 may be power lines carrying alternating current (AC) or direct current (DC) power signals. When plug 128 of cable 126 is connected to connector port 120 (i.e., a mating connector in device 10), signal paths 156 and 160 can be coupled to corresponding power signal paths in device 10. Inductors 164 and 162 may be interposed within these power lines to block radio-frequency interference signals and thereby prevent interference from disrupting proper operation of the circuitry in device 10. The close proximity between near-field coupling structure 172 of port 120 and lines such as lines 156 and 160 of plug 128 gives rise to electromagnetic near-field coupling between transceiver circuitry 90 and line 156 and/or line 160. This allows line 156 and/or line 160 in flexible cable portion 130 of cable 126 to serve as a portion of antenna 40 (e.g., as antenna resonating element 106). Arrangements of the type shown in FIG. 17 may be used to implement antennas in configurations where a standard power cable or other type of cable 126 is coupled to device 10.

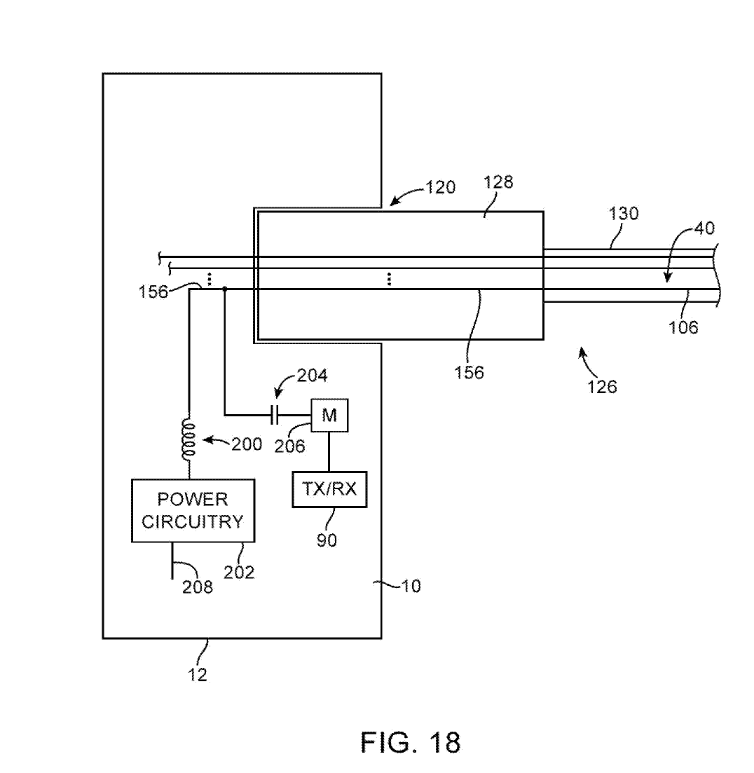

FIG. 18 is a diagram of an illustrative configuration for device 10 and cable 126 in which radio-frequency transceiver circuitry 90 is directly coupled to a power line or other signal line in cable 146. As shown in FIG. 18, cable 126 may include flexible cable portion 130 and a connector such as plug 128. Plug 128 may have contacts that mate with corresponding contacts in a connector associated with connector port 120 of device 10. Cable 126 has signal lines such as illustrative signal lines 156. Signals lines such as signal line 156 may be used to carry power signals or other signals (e.g., analog and/or digital data signals). In the example of FIG. 18, signal line 156 is a power line. The portion of path 156 that extends within device 10 is coupled to power circuitry 202 via inductor 200. Inductor 200 blocks radio-frequency signals such as antenna signals and thereby prevents interference from reaching power circuitry 202. Power circuitry 202 may include a power management unit integrated circuit or other circuitry for regulating the flow of power within device 10 on one or more internal power supply lines such as line 208. Power circuitry 202 may, if desired, include AC-to-DC power conversion circuitry for converting AC power on paths such as path 156 into DC power for distribution to internal circuitry in device 10 over DC power supply lines such as power supply line 208. Alternatively, power supply lines such as power supply line 156 may be DC power supply lines.

The presence of conductive lines in cable portion 130 such as line 156 allows these lines to serve as antenna resonating element 106 in antenna 40. Radio-frequency transceiver circuitry 90 may be coupled to lines such as line 156 via impedance matching circuit 206 and capacitor 204. Capacitor 204 allows signals such as radio-frequency antennas signals to pass from transceiver circuitry 90 to antenna resonating element 106 of antenna 40 and to pass from antenna resonating element 106 of antenna 40 to transceiver circuitry 90, while blocking lower frequency signals such as AC or DC power signals and thereby preventing these lower frequency signals from interfering with the proper operation of radio-frequency transceiver circuitry 90.

With a configuration of the type shown in FIG. 18, path 156 may serve as an external antenna for device 10 that can improve antenna performance. Cable 126 may, if desired, be a standard power or data cable that includes paths such as path 156 that are suitable for forming antenna structures 140. In the example of FIG. 18, transceiver circuitry 90 has been coupled to a single path in cable 126 (i.e., path 156). If desired, multiple paths such as path 156 may be coupled to transceiver circuitry 90 (i.e., one or more antenna resonating elements 106 or other antenna structures may be formed from wires 156).

The foregoing is merely illustrative and various modifications can be made by those skilled in the art without departing from the scope and spirit of the described embodiments. The foregoing embodiments may be implemented individually or in any combination.

What is claimed is:

1. An electronic device configured to receive an external cable that has a plug and a signal wire, comprising:
a housing;
a connector port in the housing that receives the plug; and
radio-frequency transceiver circuitry in the housing that is coupled to the signal wire, wherein the signal wire serves as an antenna and wherein the radio-frequency transceiver circuitry receives antenna signals using the antenna.

2. The electronic device defined in claim 1 wherein the external cable comprises a power cable and wherein the signal wire comprises a power line.

3. The electronic device defined in claim 2 further comprising power circuitry that is coupled to the signal wire.

4. The electronic device defined in claim 3 wherein the radio-frequency transceiver circuitry is coupled to the signal line by a capacitor.

5. The electronic device defined in claim 4 wherein the power circuitry is coupled to the signal wire by an inductor.

6. The electronic device defined in claim 5 wherein the radio-frequency transceiver circuitry transmits antenna signals using the antenna.

7. The electronic device defined in claim 6 further comprising a display in the housing.

8. The electronic device defined in claim 1 wherein the external cable comprises a data cable having a plurality of data lines and wherein the signal wire forms one of the plurality of data lines.

9. An electronic device configured to receive an external cable that has a plug and that has a conductive structure, comprising:
a housing;
a connector port in the housing that receives the plug, wherein the connector port has contacts that mate with corresponding contacts in the plug;
a near-field coupling structure; and
radio-frequency transceiver circuitry in the housing that is coupled to the near-field coupling structure, wherein conductive structure serves as an antenna and wherein the radio-frequency transceiver circuitry receives antenna signals using the antenna.

10. The electronic device defined in claim 9 wherein the near-field coupling structure comprises a capacitor electrode mounted at the connector port.

11. The electronic device defined in claim 9 wherein the near-field coupling structure comprises an inductor mounted at the connector port.

12. The electronic device defined in claim 9 wherein the plug includes a first capacitor electrode connected to the conductive structure and wherein the near-field coupling structure comprises a capacitively coupled second capacitor electrode.

13. The electronic device defined in claim 9 wherein the plug includes a first inductor connected to the conductive structure and wherein the near-field coupling structure comprises an inductively coupled second inductor.

14. The electronic device defined in claim 9 wherein the external cable comprises a power cable, wherein the conductive structure comprises a power line in the power cable, and wherein the near-field coupling structure is electromagnetically near-field coupled to the power line.

15. The electronic device defined in claim 9 wherein the external cable comprises a data cable, wherein the conductive structure comprises a data line in the data cable, and wherein the near-field coupling structure is electromagnetically near-field coupled to the data line.

16. An electronic device configured to receive an external cable that has a plug and that has a signal wire, comprising:
a housing;
a connector port in the housing that receives the plug, wherein the connector has contacts that mate with corresponding contacts in the plug;
an antenna structure selected from the group consisting of: an antenna structure in the connector port and an antenna structure on the external cable; and
radio-frequency transceiver circuitry in the housing that is coupled to the antenna structure, wherein the radio-frequency transceiver circuitry receives antenna signals using the antenna structure.

17. The electronic device defined in claim 16 wherein the antenna structure comprises an antenna resonating element mounted in the connector port and wherein the radio-frequency transceiver circuitry is connected to the antenna structure and transmits antenna signals using the antenna structure.

18. The electronic device defined in claim 17 wherein the antenna structure comprises an antenna resonating element on the external cable and wherein the radio-frequency transceiver circuitry is coupled to the antenna structure and transmits antenna signals using the antenna structure.

19. The electronic device defined in claim 18 further comprising a near-field coupling structure in the connector port that is coupled to the antenna resonating element by electromagnetic near-field coupling.

20. The electronic device defined in claim 18 further comprising a spring that couples the antenna resonating element to the radio-frequency transceiver circuitry.
